(19) United States
(12) Patent Application Publication
(10) Pub. No.: US 2025/0214277 A1
(43) Pub. Date: Jul. 3, 2025

(54) Water and Quality Management of Oil-Based Wood Preservatives

(71) Applicant: Arxada AG, Visp (CH)

(72) Inventors: Jessica Myers, Leeds, West Yorkshire (GB); Stephen Uphill, Castleford (GB); Hannah Griffiths, Visp (CH); Andrew Hughes, Visp (CH); Ed Webster, Visp (CH); Jamie Nuttall, Leeds, West Yorkshire (GB)

(21) Appl. No.: 18/851,206

(22) PCT Filed: Mar. 31, 2023
(86) PCT No.: PCT/IB2023/053278

§ 371 Date: Sep. 26, 2024

Related U.S. Application Data
(60) Provisional application No. 63/427,131, filed on Nov. 22, 2022.
(60) Provisional application No. 63/325,838, filed on Mar. 31, 2022.

(51) Int. Cl. B27K 3/10; B01D 17/02; B27K 3/22; B27K 3/52; C02F 1/24; C02F 1/40; C02F 101/32; C02F 103/34

(52) U.S. Cl. CPC B27K 3/10; B01D 17/0205; B01D 17/0214; B27K 3/22; B27K 3/52; C02F 1/24; C02F 1/40; C02F 2101/32; C02F 2103/34

(57) ABSTRACT

A system for treating wood includes a water separation tank in fluid communication with a pressure tank such that a mixture of water and treatment fluid are flowable from the pressure tank to the water separation tank. The water separation tank includes a bottom wall with an outlet. The bottom wall is sloped towards the outlet. Water from the mixture of water and treatment fluid is flowable out of the water separation tank through the outlet.

### RELATED APPLICATIONS

The present application is based on and claims priority to U.S. Provisional Application Ser. No. 63/325,838 filed on Mar. 31, 2022 and U.S. Provisional Application Ser. No. 63/427,131 filed on Nov. 22, 2022, and, which are incorporated herein by reference.

### BACKGROUND

Wood and wood-based products used for heavy-duty applications (such as, but not limited to, poles, sleepers, and agricultural posts) usually contain 20-40% moisture prior to preservative treatment, which can migrate into the treatment solution during treatment, and, if not managed correctly, can lead to, amongst other things, destabilization of the preservative, excessive corrosion, and oxidation of the oil, all of which result in solids formation (seen as sludge or varnish) in the treatment solution.

Typically, oil-based wood preservatives, such as creosote, have been used at temperatures above one hundred degrees Celsius (100° C.). At such temperatures and when subject to a vacuum (that is negative pressure), water can be boiled off in-process and removed from the system. More modern, Cu-organic type oil-based wood preservative systems, such as Tanasote™ S40, cannot be used at such high temperatures due to chemical instability. Thus, lower application temperatures are required for the modern Cu-organic type oil-based wood preservative systems, and any moisture removed from the timber remains in the treatment fluid, which can cause instability of the treatment fluid system.

In view of the above, a need exists for improved systems and methods to overcome such water management and instability issues, resulting in acceptable moisture contents and preventing destabilization and oxidation effects when used at temperatures less than one hundred degrees Celsius (100° C.).

### SUMMARY

Aspects and advantages of the invention will be set forth in part in the following description, may be apparent from the description, or may be learned through practice of the invention.

In an example embodiment, a system for treating wood includes a pressure tank configured for receipt of wood for treatment and a storage tank configured for containing a treatment fluid. The storage tank is in fluid communication with the pressure tank such that the treatment fluid is flowable from the storage tank to the pressure tank. A heater is configured to heat the treatment fluid within the pressure tank to a temperature less than one hundred degrees Celsius. A water separation tank is in fluid communication with the pressure tank such that a mixture of water and treatment fluid are flowable from the pressure tank to the water separation tank. The water separation tank includes a bottom wall, a first outlet, and a second outlet. The bottom wall is sloped towards the first outlet. The second outlet is positioned above the first outlet along a vertical direction. The water from the mixture of water and treatment fluid is flowable out of the water separation tank through the first outlet. The treatment fluid of the mixture of water and treatment is flowable out of the water separation tank through the second outlet. The second outlet is in fluid communication with the storage tank such that the treatment fluid is flowable from the water separation tank to the storage tank.

In a first example aspect, the bottom wall may be a conical bottom wall or a domed bottom wall, and the first outlet may be positioned at a nadir of the bottom wall.

In a second example aspect, the system may also include a recovery line and a recovery pump. The recovery line may extend between the pressure tank and the water separation tank. The recovery pump may be coupled to the recovery line, and the recovery pump may be operable to flow the mixture of water and treatment fluid from the pressure tank to the water separation tank through the recovery line.

In a third example aspect, the system may include a supply line and a supply pump. The supply line may extend between the storage tank and the pressure tank. The supply pump may be coupled to the supply line, and the supply pump may be operable to flow the treatment fluid from the storage tank to the pressure tank through the supply line.

In a fourth example aspect, the system may also include a water removal system separate from the water separation tank. The water removal system may be operable to remove water from the treatment fluid. The water removal system may include one or more of a desorber, a vacuum condenser, and a centrifuge.

In a fifth example aspect, the storage tank may include an agitator operable to agitate the treatment fluid within the storage tank.

In a sixth example aspect, the water separation tank may include a sparge system whereby either air or nitrogen is passed through the fluid in the tank to aid separation of the water and oil.

In a seventh example aspect, a vacuum may be applied to the separation tank to aid water removal.

In an eighth example aspect, any combination of [0006-0012] may be employed to aid water separation from the oil based wood preservative.

In a ninth example aspect, a volume of the water separation tank may be no less than two thousand liters and no greater than twenty thousand liters, and a volume of the storage tank may be no less than twenty-five thousand liters and no greater than three hundred thousand liters.

In a tenth example aspect, the water separation tank may be a vertical water separate tank that is elongated along the vertical direction.

Each of the ten example aspects recited above may be combined with one or more of the other example aspects recited above in certain embodiments. For instance, all of the seven example aspects recited above may be combined with one another in some embodiments. As another example, any combination of two, three, four, five, or more of the seven example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

In another example embodiment, a method for treating wood includes: exposing wood within a pressure tank to a treatment fluid, a temperature of the treatment fluid being less than one hundred degrees Celsius while the wood is exposed to the treatment fluid within the pressure tank; after exposing the wood to the treatment fluid, transferring a mixture of water and treatment fluid from the pressure tank to a water separation tank, the water separation tank including a bottom wall sloped towards an outlet; and transferring the water from the mixture of water and treatment fluid out of the water separation tank through the outlet.

In an eleventh example aspect, the water separation tank may be a vertical water separate tank that is elongated along the vertical direction. The bottom wall may be a conical bottom wall or a domed bottom wall. The outlet may be positioned at a nadir of the bottom wall.

In a twelfth example aspect, the method may also include removing water from the treatment fluid with a water removal system that is separate from the water separation tank. The water removal system may include one or more of a desorber, a vacuum condenser, and a centrifuge.

In a thirteenth example aspect, the method may also include agitating the treatment fluid within the storage tank.

In a fourteenth example aspect, the temperature of the treatment fluid may be no less than forty degrees Celsius and no greater than ninety-five degrees Celsius while the wood is exposed to the treatment fluid within the pressure tank.

In a fifteenth example aspect, the treatment fluid may include an oil and a micronized copper compound. A particle size of the micronized copper compound may be no less than five nanometers and no greater than five thousand nanometers. The treatment fluid may further include an organic biocide.

In a sixteenth example aspect, the method may also include separating the water from the treatment fluid in the water separation tank for no less than ten minutes and no greater than one hundred twenty minutes after transferring the mixture of water and treatment fluid from the pressure tank to the water separation tank. The method may further include removing the wood from the pressure tank while the water separates from the treatment fluid in the water separation tank.

In a seventeenth example aspect, the mixture of water and treatment fluid may be transferred from the pressure tank to the water separation tank after a final vacuum cycle of a treatment cycle.

In an eighteenth example aspect, the treatment fluid may be substantially free of creosote.

Each of the eight example aspects recited above, i.e., the eleventh through the eighteenth example aspects, may be combined with one or more of the other example aspects recited above in certain embodiments. For instance, all of the eight example aspects recited above may be combined with one another in some embodiments. As another example, any combination of two, three, four, five, or more of the eight example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

In another example embodiment, a system for treating wood includes a pressure tank configured for receipt of wood for treatment and a storage tank configured for containing a treatment fluid. The storage tank is in fluid communication with the pressure tank such that the treatment fluid is flowable from the storage tank to the pressure tank. A heater is configured to heat the treatment fluid within the pressure tank to a temperature less than one hundred degrees Celsius. A water separation tank is in fluid communication with the pressure tank such that a mixture of water and treatment fluid are flowable from the pressure tank to the water separation tank. The water separation tank includes a bottom wall with an outlet. The bottom wall is sloped towards the outlet. The water from the mixture of water and treatment fluid is flowable out of the water separation tank through the outlet.

In a nineteenth example aspect, the bottom wall may be a conical bottom wall or a domed bottom wall, and the outlet may be positioned at a nadir of the bottom wall.

In a twentieth example aspect, the system may also include a recovery line and a recovery pump. The recovery line may extend between the pressure tank and the water separation tank. The recovery pump may be coupled to the recovery line, and the recovery pump may be operable to flow the mixture of water and treatment fluid from the pressure tank to the water separation tank through the recovery line.

In a twenty-first example aspect, the system may include a supply line and a supply pump. The supply line may extend between the storage tank and the pressure tank. The supply pump may be coupled to the supply line, and the supply pump may be operable to flow the treatment fluid from the storage tank to the pressure tank through the supply line.

In a twenty-second example aspect, the system may also include a water removal system separate from the water separation tank. The water removal system may be operable to remove water from the treatment fluid. The water removal system may include one or more of a desorber, a vacuum condenser, and a centrifuge.

In a twenty-third example aspect, the storage tank may include an agitator operable to agitate the treatment fluid within the storage tank.

In a twenty-fourth example aspect, a volume of the water separation tank may be no less than two thousand liters and no greater than twenty thousand liters, and a volume of the storage tank may be no less than twenty-five thousand liters and no greater than three hundred thousand liters.

In a twenty-fifth example aspect, the water separation tank may be a vertical water separate tank that is elongated along the vertical direction.

Each of the seven example aspects recited above, i.e., the nineteenth through the twenty-fourth example aspects, may be combined with one or more of the other example aspects recited above in certain embodiments. For instance, all of the seven example aspects recited above may be combined with one another in some embodiments. As another example, any combination of two, three, four, five, or more of the seven example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features and aspects, embodiments and advantages of the present invention will become better understood with reference to the following description and appended claims.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a system for treating wood according to an example embodiment of the present subject matter.

FIG. 2 is a schematic view of a water separation tank of the example system of FIG. 1.

FIG. 3 is a schematic view of the water separation tank of FIG. 2 according to another example embodiment of the present subject matter.

FIG. 4 illustrates a method for treating wood according to an example embodiment of the present subject matter.

FIGS. 5 through 11 are plots of various experimental data.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to systems for treating wood that include a water separation tank in fluid communication with a pressure tank such that a mixture of water and treatment fluid are flowable from the pressure tank to the water separation tank. A bottom wall of the water separation tank may be shaped to facilitate removal of water from the water separation tank. For instance, the bottom wall may be sloped towards an outlet for the water. Moreover, the bottom wall may be cone or dome shaped with the outlet for the water positioned proximate a nadir of the cone or dome. Such shaping of the bottom wall may advantageously facilitate removal of water from the water storage tank, e.g., by funneling water separated from the treatment fluid towards the outlet for the water. The water separation tank may also be vertically oriented, e.g., such that that the water separation tank is elongated along a vertical direction. Such orientation of the water separation tank may advantageously facilitate removal of water from the water storage tank, e.g., by concentrating the water at the bottom wall within a relatively smaller area relative to horizontally oriented tanks. Other benefits and features of the systems for treating wood and the water separation tank will be described below.

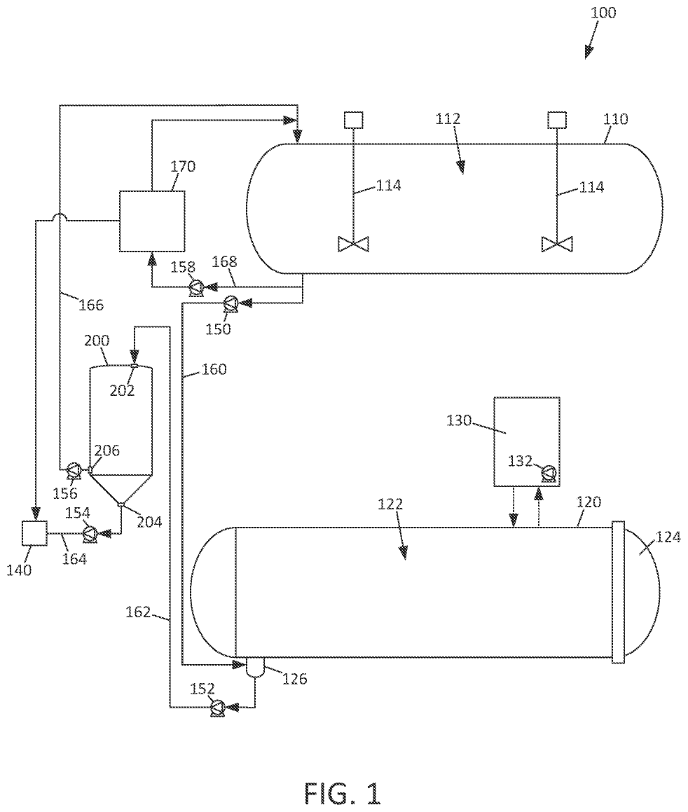

FIG. 1 is a schematic view of a system 100 for treating wood according to an example embodiment of the present subject matter. As shown in FIG. 1, system 100 may include a storage tank 110, a pressure tank 120, and a heater 130. Storage tank 110 may be configured for containing a treatment fluid, such as an oil-based treatment fluid therein. For instance, storage tank 110 may define an internal volume 112 for containing the treatment fluid. In certain example embodiments, internal volume 112 of storage tank 110 may be no less than twenty-five thousand liters (25,000 L) and no greater than three hundred thousand liters (300,000 L). Thus, storage tank 110 may be sized for containing a large volume of the treatment fluid, such as more treatment fluid than is used during each wood treatment operation within pressure tank 120. It will be understood that in certain example embodiments, storage tank 110 may be configured as multiple tanks plumbed together, e.g., in series or in parallel, and a collective volume of the multiple tanks may correspond to the internal volume 112 of storage tank 110 described above.

Storage tank 110 may include one or more agitators 114. Agitators 114 may be operable to agitate the treatment fluid within storage tank 110. Agitation of the treatment fluid within storage tank 110 may advantageously assist with keeping solids suspended within the treatment fluid and thereby limiting or preventing solids formation (“sludge” or “varnish”) within storage tank 110 or other portions of system 100. Each agitator 114 may include one or more of a paddle stirrer, a sparger, or a recirculation pump for agitating the treatment fluid within storage tank 110.

In example embodiments, storage tank 110 may be referred to an operation storage tank. Thus, e.g., storage tank 110 may be configured for containing a working volume of treatment fluid, including recirculated, post-treatment treatment fluid in pressure tank 120. Moreover, storage tank 110 may be configured for containing a bulk volume of treatment fluid for circulation through system 100. System 100 may also include one or more additional storage tanks (not shown), such as a bulk storage tank, that also contain the treatment fluid therein. The bulk storage tank may be configured for receipt of the treatment fluid from a tanker that delivers the treatment fluid to the plant with system 100. The treatment fluid in the bulk storage tank may be pumped to storage tank 110 for circulation through other portions of system 100.

Storage tank 110 may be in fluid communication with pressure tank 120 such that the treatment fluid in storage tank 110 is flowable from storage tank 110 to pressure tank 120. For example, a supply line 160 may extend between storage tank 110 and pressure tank 120, and the treatment fluid in storage tank 110 may flow from storage tank 110 to pressure tank 120 through supply line 160. A supply pump 150 may be coupled to supply line 160 and may be operable to flow the treatment fluid in storage tank 110 from storage tank 110 to pressure tank 120 through supply line 160. For instance, supply pump 150 may be activated to draw the treatment fluid from storage tank 110 and urge the treatment fluid to pressure tank 120 through supply line 160.

Pressure tank 120 may be configured for receipt of wood for treatment. For example, a load of wood, such utility poles, fence posts, railway ties, etc., may be loaded into pressure tank 120 through an opening at an end of pressure tank 120. A door 124 may be opened to allow access to an interior volume 122 of pressure tank 120 through the opening, and door 124 may be closed to seal interior volume 122 of pressure tank 120 and allow pressurization of interior volume 122 during treatment of the wood within pressure tank 120. Thus, pressure tank 120 may be configured for horizontal loading in certain example embodiments, such as shown in FIG. 1; however, pressure tank 120 may also be configured for vertical loading in alterative example embodiments. Pressure tank 120 may also be referred to as an autoclave herein.

Pressure tank 120 may be configured for containing treatment fluid from the storage tank 110 within internal volume 122, e.g., that also contains the wood for treatment. In certain example embodiments, internal volume 122 of pressure tank 120 may be no less than forty thousand liters (40,000 L) and no greater than three hundred thousand liters (300,000 L). Thus, pressure tank 120 may be sized for containing a load of wood for treatment and for containing the pressurized treatment fluid. The wood treated within pressure tank 120 may be any suitable species, such as one or more of pine, spruce, cedar, fir, hemlock, oak, maple, cherry, eucalyptus, poplar, beech, and aspen.

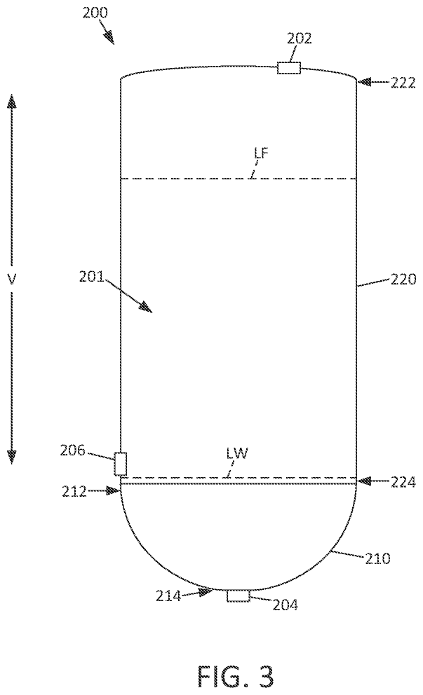

Heater 130 may be configured to heat the treatment fluid within pressure tank 120. Thus, heater 130 may be operable to increase a temperature of the treatment fluid relative to an ambient temperature around system 100. For example, heater 130 may includes one or more of an electric resistance heating element, a gas burner, an induction heating element, and a heat pump to heat the treatment fluid within pressure tank 120. As shown in FIG. 3, heater 130 may include a pump 132 to circulate the treatment fluid from pressure tank 120 during operation of heater 130. Thus, heater 130 may be positioned remote from pressure tank 120 in certain example embodiments; however, heater 130 may be configured to directly heat pressure tank 120 and/or the treatment fluid within pressure tank 120 in alternative example embodiments.

Heater 130 may be configured to heat the treatment fluid within pressure tank 120 to a temperature less than one hundred degrees Celsius (100° C.) in certain example embodiments, such as from about forty degrees Celsius (40° C.) to about ninety-five degrees Celsius (95° C.), such as from about fifty degrees Celsius (50° C.) to about seventy-five degrees Celsius (75° C.), such as from about fifty-five degrees Celsius (55° C.) to about seventy degrees Celsius (70° C.), or any range therebetween. As discussed in greater detail below, the treatment fluid may include an oil-based preservative with one or more biocidal agents. For instance, the oil-based preservative may include copper (Cu) and at least one organic co-biocidal agent. Such oil-based preservative may be an alternative to creosote, and, e.g., the treatment fluid may be substantially free of creosote in certain example embodiments. The oil-based preservative may be unstable at high temperatures, such as those greater than one hundred degrees Celsius (100° C.). Thus, heater 130 may be configured to heat the treatment fluid to temperatures less than one hundred degrees Celsius (100° C.) in order to advantageously limit or prevent chemical instability of the oil-based preservative.

Heating the treatment fluid to temperatures less than one hundred degrees Celsius (100° C.) can assist with stability of the treatment fluid but can also lead to accumulation of water within the treatment fluid. Moreover, wood within the internal volume 122 of pressure tank 120 may reject water when subjected to a vacuum within pressure tank 120, and the water may migrate to the treatment fluid within pressure tank 120. For instance, the wood in pressure tank 120 may start with between twenty percent and forty percent (20%-40%) moisture content at a beginning of a treatment operation within pressure tank 120, and water from the wood may transfer to the treatment fluid by the end of the treatment operation within pressure tank 120. For example, the treatment fluid may include no less than three percent (3%) water and no more than seven percent (7%) water by weight by the end of the treatment operation within pressure tank 120. Excess water within the treatment fluid can cause significant problems for system 100, such as instability of the oil-based preservative, corrosion, and oxidation of the oil, all of which can lead to negative solids formation (“sludge” or “varnish”) within system 100. Thus, system 100 may also include features for removing or managing water within system 100.

As shown in FIG. 1, system 100 may include a water separation tank 200. Water separation tank 200 may be in fluid communication with pressure tank 120. Thus, a mixture of water and treatment fluid may be flowable from pressure tank 120 to water separation tank 200. For example, a recovery line 162 may extend between pressure tank 120 and water separation tank 200, and the mixture of water and treatment fluid from pressure tank 120 may flow from pressure tank 120 to water separation tank 200 through recovery line 162. A recovery pump 152 may be coupled to recovery line 162 and may be operable to flow the mixture of water and treatment fluid in pressure tank 120 from pressure tank 120 to water separation tank 200 through recovery line 162. For instance, recovery pump 152 may be activated to draw the mixture of water and treatment fluid from pressure tank 120 and urge the mixture of water and treatment fluid to water separation tank 200 through recovery line 162. Water separation tank 200 may be separate from pressure tank 120. Thus, recovered water and treatment fluid may be transferred from pressure tank to water separation tank 200 after treatment of the wood within pressure tank 120.

Water separation tank 200 may be configured to separate water from treatment fluid within an interior volume 201 of water separation tank 200. For example, water may separate from the treatment fluid (e.g., the oil-based preservative) within water separation tank 200 by gravity due to the density differential between water and the treatment fluid. Moreover, water may accumulate at a bottom portion of the interior volume 201 of water separation tank 200, and the treatment fluid may accumulate over the water within the interior volume 201 of water separation tank 200. Thus, water may be efficiently separated from the treatment fluid within water separation tank 200. In certain example embodiments, interior volume 201 of water separation tank 200 may be no less than two thousand liters (2,000 L) and no greater than twenty thousand liters (20,000 L). Thus, water separation tank 200 may be sized for containing the volume of treatment fluid used within pressure tank 120 for treating wood during each operating cycle.

Water separation tank 200 may include a first outlet 204 and a second outlet 206. After separating the water from the treatment fluid within water separation tank 200, the water within water separation tank 200 may exit water separation tank 200 via first outlet 204, and the treatment fluid within water separation tank 200 may exit water separation tank 200 via second outlet 206. In certain example embodiments, water separation tank 200 may include only outlet 204, and both the flow of water and the flow of treatment fluid may exit water separation tank 200 via outlet 204. For example, the flow of water may first exit water separation tank 200 via outlet 204, and the flow of treatment fluid may subsequently exit water separation tank 200 via outlet 204. A valve or other suitable mechanism may be utilized to direct the separate flows of water and treatment fluid within system 100 in such example embodiments.

First outlet 204 may be in fluid communication with a drain 140. Thus, the water from water separation tank 200 may exit water separation tank 200 at first outlet 204 and flow to drain 140, at which the water may exit system 100. As an example, a drain line 164 may extend between first outlet 204 of water separation tank 200 and drain 104, and the water from water separation tank 200 may flow from water separation tank 200 to drain 140 through drain line 164. A drain pump 154 may be coupled to drain line 164 and may be operable to flow the water in water separation tank 200 to drain 140 through drain line 164. For instance, drain pump 154 may be activated to draw the water in water separation tank 200 through first outlet 204 and urge the water to drain 140 through drain line 164. Drain 140 may be connected to a wastewater collection container or other suitable recovery for water exiting system 100.

Second outlet 206 may be in fluid communication with storage tank 110. Thus, the treatment fluid from storage tank 110 may exit water separation tank 200 at second outlet 206 and flow to storage tank 110, at which the treatment fluid from water separation tank 200 may recovered into the treatment fluid in storage tank 110 for subsequent use in treatment of wood in pressure tank 120. As an example, a retrieval line 166 may extend between second outlet 206 of water separation tank 200 and storage tank 110, and the treatment fluid from water separation tank 200 may flow from water separation tank 200 to storage tank 110 through retrieval line 166. A retrieval pump 156 may be coupled to retrieval line 166 and may be operable to flow the treatment fluid in water separation tank 200 to storage tank 110 through retrieval line 166. For instance, retrieval pump 156 may be activated to draw the treatment fluid in water separation tank 200 through second outlet 206 and urge the treatment fluid to storage tank 110 through retrieval line 166.

System 100 may also include a water removal system 170 operable to remove water from treatment fluid in system 100. Water removal system 170 may be separate from water separation tank 200. Thus, e.g., water removal system 170 may operate in combination with water separation tank 200 to remove water from treatment fluid in system 100. For example, water removal system 170 may supplement water separation tank 200 for removal of water from treatment fluid in system 100. Water removal system 170 may include one or more of a desorber, a vacuum condenser, and a centrifuge, each of which may be configured to remove water from the treatment fluid. In certain example embodiments, water removal system 170 may include two or more desorbers, vacuum condensers, and centrifuges, e.g., connected and operable in parallel, to remove water from treatment fluid in system 100. In addition, system 100 may include one or more additional known mechanisms for water/oil gravity separation, heat distillation, vacuum distillation, and/or air sparging for assisting with removal of water from treatment fluid in system 100.

System 100 may also include a sparge system connected to the water separation tank 170. For instance, the water separation tank 170 may include a sparge system configured for passing air and/or nitrogen through the fluid in the tank to aid separation of the water and oil. For instance, air sparging may increase the rate of water removal compared to systems without air sparging.

In the example embodiment shown in FIG. 1, water removal system 170 is connected with storage tank 110 and is operable to remove water from the treatment fluid in storage tank 110. As an example, a recirculation line 168 may extend between storage tank 110 and water removal system 170, and the treatment fluid from storage tank 110 may flow from storage tank 110 to water removal system 170 through recirculation line 168. The recirculation line 168 may also extend back from water removal system 170 to storage tank 110, and the treatment fluid (e.g., with less water therein) from water removal system 170 may flow back to storage tank 110 from water removal system 170 through recirculation line 168. A recirculation pump 158 may be coupled to recirculation line 168 and may be operable to flow the treatment fluid through water removal system 170 via recirculation line 168. For instance, recirculation pump 158 may be activated to draw the treatment fluid from storage tank 110 to water removal system 170 and then urge the treatment fluid (e.g., with less water therein) from water removal system 170 back to storage tank 110 through recirculation line 168. Water from water removal system 170 may flow to drain 140 for removal from system 100 as described above.

It will be understood that the above-described arrangement of water removal system 170 within system 100 is provided by way of example only. In other example embodiments, water removal system 170 may be installed in series with water separation tank 200, e.g., between water separation tank 200 and storage tank 110 on retrieval line 166. In other example embodiments, water removal system 170 may installed in parallel with water separation tank 200. In other example embodiments, water removal system 170 may be installed separately, in series, or in parallel with storage tank 110, pressure tank 120, a bulk storage tank, a pump complex, or other tanks used for storage or operation of system 100, either while in operation or off-line in storage. Other arrangements of water removal system 170 within system 100 are also within the scope of the present subject matter.

System 100 may also include a filter (not shown) that is configured to remove fine solids, e.g., from a tenth of a micron (0.1 μm) to one hundred microns (100 μm) to further assist with limiting or preventing solids formation (“sludge” or “varnish”) within storage tank 110 or other portions of system 100. System 100 may further include various conventional components not illustrated or described in detail herein for the sake of brevity. For example, system 100 may include a compressed air supply system, a steam supply system, a condensate removal system, a chiller system, etc.

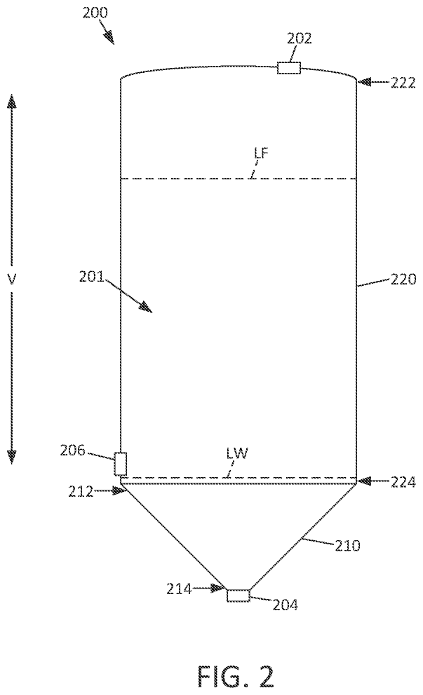

Water separation tank 200 will be described in greater detail below with reference to FIG. 2. As shown in FIG. 2, water separation tank 200 may include a bottom wall 210 and a sidewall 220. Bottom wall 210 may extend between a top portion 212 and a bottom portion, e.g., along a vertical direction V. Top portion 212 of bottom wall 210 may be disposed above bottom portion 214 of bottom wall 210 along the vertical direction V. Sidewall 220 may also extend between a top portion 222 and a bottom portion 224, e.g., along the vertical direction V. Top portion 222 of sidewall 220 may be disposed above bottom portion 224 of sidewall 220 along the vertical direction V. Bottom wall 210 may be connected to sidewall 220. Moreover, top portion 212 of bottom wall 210 may be connected to bottom portion 224 of sidewall 220.

Water separation tank 200 may be a vertical water separate tank, e.g., that is elongated along the vertical direction V. For instance, sidewall 220 may be elongated alone the vertical direction V. Thus, e.g., a length of sidewall 220 along the vertical direction V between top and bottom portions 222, 224 of sidewall 220 may be no less than two time (2X) greater, such as no less than three times (3X) greater, than a width of sidewall 220 that is perpendicular to the length of sidewall 220.

Bottom wall 210 may be shaped such that bottom wall 210 is sloped towards first outlet 204. For example, as shown in FIG. 2, bottom wall 210 may have a conical shape, e.g., such that bottom wall 210 has a uniformly decreasing circular cross-sectional area between top and bottom portions 212, 214 of bottom wall 210. First outlet 204 may be positioned at a nadir or lowest point of the cone of bottom wall 210. In another example embodiment, shown in FIG. 3, bottom wall 210 may have a dome shape, e.g., such that bottom wall 210 has a non-uniformly decreasing circular cross-sectional area between top and bottom portions 212, 214 of bottom wall 210. First outlet 204 may be positioned at a nadir or lowest point of the dome of bottom wall 210. Such shapes of bottom wall 210 are provided by way of example only. Other shapes for bottom wall 210 that slope towards first outlet 204 are within the scope of the present application.

By sloping towards first outlet 204, bottom wall 210 may be shaped to facilitate removal of water from water separation tank 200. As noted above, water may separate from the treatment fluid (e.g., the oil-based preservative) within water separation tank 200 by gravity due to the density differential between water and the treatment fluid. Moreover, water may accumulate at bottom wall 210, and the treatment fluid may accumulate over the water within the interior volume 201 of water separation tank 200. As shown in FIG. 2, the level of water LW within water separation tank 200 is below the level of the treatment fluid LF in the interior volume 201 of water separation tank 200. By sloping towards first outlet 204, bottom wall 210 may funnel water within water separation tank 200 towards first outlet 204. Moreover, as the volume of water within water separation tank 200 decreases, the shape of bottom wall 210 may flow the water remaining within water separation tank 200 towards first outlet 204. In contrast, flat bottom walls distribute the water over a wider area, which makes complete removal of the water difficult.

Second outlet 206 may be positioned above first outlet 204 along the vertical direction V. For example, second outlet 206 may be positioned on sidewall 220, e.g., at or proximate bottom portion 224 of sidewall 220. Second outlet 206 may be positioned above the level of water LW within water separation tank 200, e.g., the expected level of water within water separation tank 200, such that the treatment fluid can be removed from water separation tank 200 before the water.

Turning back to FIG. 1, as noted above, system 100 may be configured for use with an oil-based preservative that includes one or more biocidal agents. For instance, the oil-based preservative may include copper (Cu) and at least one co-biocidal agent. Such oil-based preservative may be an alternative to creosote, and, e.g., the treatment fluid may be substantially free of creosote in certain example embodiments. In one example embodiment, copper may be present in the oil-based preservative from about 0.1% by weight of the oil-based preservative to about 20% by weight of the oil-based preservative, such as from about 0.5% by weight to about 10% by weight, such as from about 3% by weight to about 7% by weight, or any range therebetween. The copper may include a micronized copper compound that is no less than five nanometers (5 nm) and no greater than five thousand nanometers (5000 nm). The at least one co-biocidal may be an organic co-biocide agent, such as one or more of an isothiazolinone, a pyrethroid, a neonicotinoid, a halogenated carbamate, a succinate dehydrogenase inhibitor (SDHI), and an azole.

The one or more co-biocidal agent may have a mean particle size of from about 0.01 μm to about 25 μm, such as from about 0.1 μm to about 10 μm, such as from about 0.3 μm to about 8 μm, or any range therebetween. The at least one organic co-biocide may be present at no less than about 0.1% by weight of the oil-based preservative and no greater than about 25% by weight of the oil-based preservative, such as from about 1% by weight to about 20% by weight, such as from about 3% by weight to about 15% by weight, such as about 5% by weight to about 10% by weight, or any range therebetween.

According to example aspects of the present disclosure, the ratio of Cu (wt %) to co-biocidal agent (wt %) in the oil-based preservative may be from about 100:1 to about 1:100, such as from about 50:1 to about 1:1, such as from about 20:1 to about 1:1, or any range therebetween.

In certain example embodiments, the oil-based preservative may include a dissolved copper compound, e.g., containing an amount between 0.5% and 10% w/w elemental copper. In another example embodiment, the oil-based preservative may include a micronized copper compound, e.g., containing an amount between 0.5% and 10% w/w elemental copper, where the micronized copper compound has a particle size of 5 nanometers (5 nm) to 5000 nanometers (5000 nm). In another example embodiment, the particle size of the micronized copper compound varies by less than 50 nanometers (50 nm) after storage from week one to six months at twenty-four degrees Celsius (24° C.).

In another preferred example embodiment, the oil-based preservative may further include one or more of boron based preservatives, such as boric acid, sodium salt of borates, triazole compounds, pentachlorophenol, sodium fluoride, and Succinate Dehydrogenase Inhibitors (SDHIs). Triazoles of the oil-based preservative according to example aspects of the invention include, but are not limited to, epoxiconazole, triadimenol, propiconazole, prothioconazole, metconazole, cyproconazole, tebuconazole, flusilazole, paclobutrazol, fluconazole, isavuconazole, itraconazole, voriconazole, pramiconazole, ravuconazole, Posaconazole, mefentrifluconazole, fenbuconazole, and fuberidazole. SDHIs of the oil-based preservative according to example aspects of the invention include, but are not limited to, Flutolanil, Isofetamid, Flupyram, Fluxapyroxad, Penthiopyrad, Boscalid, Fenfuram, Caboxin, Thifluzamide, Benzovindiflupyr, Bixafen, Furametpyr, Isopyrazam, Penflufen, Penthiopyrad, and Sedaxane. In certain example embodiments, example aspects of the invention include treating wood or a wood product by contacting the wood or wood product with the oil-based preservative, as described above. The treated wood or wood product in this example embodiment may retain copper in an amount between about 0.5 kg/m³ to 4 kg/m³. In a preferred example embodiment, the treated wood or wood product may retains a copper to co-biocide ratio of an amount between about 10:1 and 200:1.

In another preferred example embodiment, the oil-based preservative may further include one or more quaternary ammonium salts, such as Didecyldimethylammonium Chloride, Didecyldimethylammonium Carbonate, Dimethylbenzyl ammonium chloride, and Didecylmethylpoly(oxyethyl)ammonium proprionate. In certain example embodiments, example aspects of the invention include treating wood or a wood product by contacting the wood or wood product with the oil-based preservative, as described above. The treated wood or wood product in this example embodiment may retain copper in an amount between about 0.5 kg/m³ to 4 kg/m³. In a preferred example embodiment, the treated wood or wood product in this example embodiment retains a copper to quat ratio of an amount between about 1:1 and 20:1.

In another preferred example embodiment, the oil-based preservative may further include one or more of Metyltetraprole, Dithianon, Dimethomorph, Fenpropimorph, Metiram, Pyraclostrobin, Picoxystrobin, Meptyldinocap, Mepanipyrim, Fluoroimide, Fenamidone, Quinoxyfen, Fluoxastrobin, Rhamnolipid, Azoxystrobin, Kresoxim-methyl, and Cyazofamid. In certain example embodiments, example aspects of the invention include treating wood or a wood product by contacting the wood or wood product with the oil-based preservative, as described above. The treated wood or wood product in this example embodiment may retain copper in an amount between about 0.5 kg/m³ to 4 kg/m³. In a preferred example embodiment, the treated wood or wood product in this example embodiment may retain a copper to co-biocide ratio of an amount between about 10:1 and 200:1.

In certain example embodiments, the oil-based preservative may be metal-free or substantially free of metal, and the oil-based preservative may include solubilised or encapsulated 4,5-Dichloro-2-n-octyl-4-isothiazolin-3-one (DCOIT). In another preferred example embodiment of the metal-free oil-based preservative, the oil-based preservative may further include one or more of boron based preservatives, such as boric acid, sodium salt of borates, triazole compounds, pentachlorophenol, sodium fluoride, and Succinate Dehydrogenase Inhibitors (SDHIs). Triazoles of the oil-based preservative according to example aspects of the invention may include, but are not limited to, epoxiconazole, triadimenol, propiconazole, prothioconazole, metconazole, cyproconazole, tebuconazole, flusilazole, paclobutrazol, fluconazole, isavuconazole, itraconazole, voriconazole, pramiconazole, ravuconazole, posaconazole, mefentrifluconazole, fenbuconazole, and fuberidazole. SDHIs of the oil-based preservative according to example aspects of the invention include, but are not limited to, Flutolanil, Isofetamid, Flupyram, Fluxapyroxad, Penthiopyrad, Boscalid, Fenfuram, Caboxin, Thifluzamide, Benzovindiflupyr, Bixafen, Furametpyr, Isopyrazam, Penflufen, Penthiopyrad, and Sedaxane. In certain example embodiments, example aspects of the invention include treating wood or a wood product by contacting the wood or wood product with oil-based preservative, as described above. The treated wood or wood product in this example embodiment may retain DCOIT in an amount between about 0.5 kg/m³ to 4 kg/m³. In a preferred example embodiment, the treated wood or wood product in this example embodiment may retain a DCOIT to co-biocide ratio of an amount between about 10:1 and 200:1.

In another preferred example embodiment, the oil-based preservative may further include one or more quaternary ammonium salts, such as Didecyldimethylammonium Chloride, Didecyldimethylammonium Carbonate, and Didecylmethylpoly(oxyethyl)ammonium proprionate. In certain example embodiments, example aspects of the invention may include treating wood or a wood product by contacting the wood or wood product with the oil-based preservative, as described above. The treated wood or wood product in this example embodiment may retain DCOIT in an amount between about 0.5 kg/m³ to 4 kg/m³. In a preferred example embodiment, the treated wood or wood product in this example embodiment may retain a DCOIT to quat ratio of an amount between about 1:1 and 20:1.

In another preferred example embodiment, the oil-based preservative may further include one or more of Metyltetraprole, Dithianon, Dimethomorph, Fenpropimorph, Metiram, Pyraclostrobin, Picoxystrobin, Meptyldinocap, Mepanipyrim, Fluoroimide, Fenamidone, Quinoxyfen, Fluoxastrobin, Rhamnolipid, Azoxystrobin, Kresoxim-methyl, and Cyazofamid. In certain example embodiments, example aspects of the invention include treating wood or a wood product by contacting the wood or wood product with the oil-based preservative described above. The treated wood or wood product in this example embodiment may retain DCOIT in an amount between about 0.5 kg/m³ to 4 kg/m³. In a preferred example embodiment, the treated wood or wood product in this example embodiment may retain a DCOIT to quat ratio of an amount between about 10:1 and 200:1.

In the preferred example embodiment, the carrier oil used for the oil-based preservative may be a base mineral oil (such as, but not limited to, API petroleum derived and synthetically modified oils which fall within API Groups 1-5, including PAOs, Alkylated Naphthalenes, Naphethenic oils and esters). In other example embodiments, the carrier oil used for the oil-based preservative may be a tall-oil derivative (such as, but not limited to, sylphat), a vegetable oil derivative (such as, but not limited to, linseed oil) derivative. In certain example embodiments, the carrier oil for the oil-based preservative may be a combination of two or more of mineral oil, tall oil, vegetable oil, and synthetic oils.

In preferred example embodiments, the carrier oil used for the oil-based preservative may contain antioxidants. In another example embodiment, the carrier oil used for the oil-based preservative may contain alkylated naphthenics, Such additives may be used in the oil at levels of about 0.1% to 5% w/w.

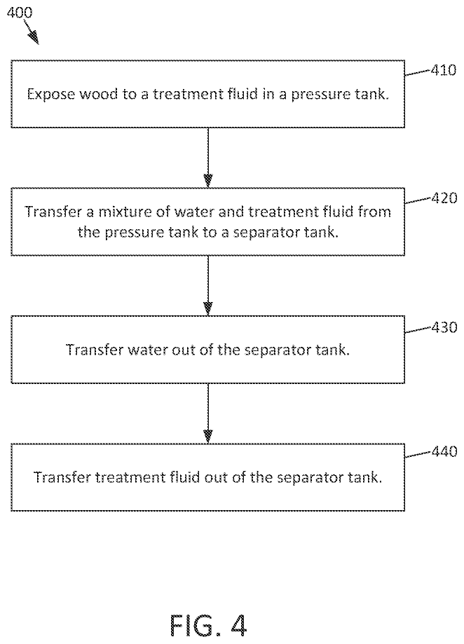

Turning now to FIG. 4, a method 400 for treating wood according to an example embodiment of the present subject matter will now be described. Method 400 may be used within system 100. Thus, method 400 is described in greater detail below in the context of system 100. However, it will be understood that method 400 may be used in other suitable systems in alternative example embodiments.

At 410, method 400 includes exposing wood within pressure tank 120 to a treatment fluid. For example, interior volume 122 of pressure tank 120 may be pressurized with the wood product and the treatment fluid, e.g., with the oil-based preservative, in order to impregnate the wood product with the treatment fluid. Immersing the wood product in the pressurized interior volume 122 of pressure tank 120 containing the treatment fluid, e.g., with the oil-based preservative, results in the treatment fluid being homogenously impregnated into the surface of the wood product rather than merely applied onto the surface or penetrating only partially or inhomogeneously into the wood product. At 410, the pressure applied to the interior volume 122 of pressure tank 120 in order to penetrate the wood product with the treatment fluid may be from about one (1) bar to about ten (10) bar, such as about two (2) bar, about three (3) bar, about four (4) bar, about five (5) bar, about six (6) bar, about seven (7) bar, about eight (8) bar, or about nine (9) bar. It is understood that the exact pressure value may depend on the wood product size and can be readily adapted by a skilled artisan.

In certain example embodiments, at 410, the interior volume 122 of pressure tank 120 may be pressurized for no less than about thirty (30) minutes to impregnate the wood product with the treatment fluid, such as no less than about sixth (60) minutes, such as no less than about one hundred and twenty (120) minutes, such as no less than about one hundred and eighty (180) minutes, such as no less than about two hundred and forty (240) minutes. In certain example embodiments, the interior volume 122 of pressure tank 120 may be pressurized for no greater than three hundred (300) minutes to impregnate the wood product with the treatment fluid, such as no greater than about two hundred (200) minutes, such as no greater than about one hundred and fifty (150) minutes, such as no greater than about one hundred (100) minutes, such as no greater than about sixty (60) minutes.

In certain example embodiments, at 410, the temperature of the oil-based preservative may be no greater than ninety degrees Celsius (90° C.) when the wood product is impregnated with the treatment fluid, such as no greater than eighty-five degrees Celsius (85° C.), such as no greater than eighty degrees Celsius (80° C.), such as no greater than seventy-five degrees Celsius (75° C.), such as no greater than seventy degrees Celsius (70° C.), such as no greater than sixty-five degrees Celsius (65° C.), such as no greater than sixty degrees Celsius (60° C.), such as no greater than fifty-five degrees Celsius (55° C.), such as no greater than fifty degrees Celsius (50° C.), such as no greater than forty-five degrees Celsius (45° C.). In certain example embodiments, at 410, the temperature of the treatment fluid may be greater than forty degrees Celsius (40° C.) when the wood product is impregnated with the treatment fluid, such as greater than fifty degrees Celsius (50° C.), such as greater than sixty degrees Celsius (60° C.), such as greater than seventy degrees Celsius (70° C.), such as greater than eighty degrees Celsius (80° C.).

At 420, after exposing the wood to the treatment fluid at 410, a mixture of water and treatment fluid may be transferred from pressure tank 120 to water separation tank 200. The mixture of water and treatment fluid may include no less than three percent (3%) water and no more than seven percent (7%) water by weight of the mixture of water and treatment fluid after being transferred from pressure tank 120 to water separation tank 200. In example embodiments, the mixture of water and treatment fluid may be transferred from pressure tank 120 to water separation tank 200 after a final vacuum cycle of 410. Within water separation tank 200, water may separate from the treatment fluid (e.g., the oil-based preservative) by gravity due to the density differential between water and the treatment fluid. Moreover, the water may be separated from the treatment fluid in water separation tank 200 for no less than ten (10) minutes and no greater than one hundred twenty (120) minutes after transferring the mixture of water and treatment fluid from pressure tank 120 to water separation tank 200 at 420. The treated wood product may be removed from pressure tank 120 while the water separates from the treatment fluid in water separation tank 200. Thus, operation of water separation tank 200 may advantageously not interfere with unloading and/or reloading of pressure tank 120.

At 430, the water may be transferred out of water separation tank 200 through first outlet 204. For example, drain pump 154 may be activated at 430 to draw the water in water separation tank 200 through first outlet 204 and urge the water to drain 140 through drain line 164. Method 400 may also include removing water from the treatment fluid with water removal system 170. Method 400 may further include agitating the treatment fluid within storage tank 110.

Advantageously, methods disclosed herein can provide treatment fluid with acceptable moisture contents, such as between one-hundredth of a percent and one-tenth percent (0.01-0.1%) water by weight of the treatment fluid, which can advantageously limit or prevent destabilization and oxidation effects during operation of system 100.

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a”, “an”, and “the” include the plural forms unless the context clearly dictates otherwise. Additionally, the term “includes” means “comprises”. The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about”. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” mean by weight as relative to another component or a percentage of the total weight in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “D50” or “D50 particle size” refers to the volume median particle size, where 50% of the particles of the sample volume have a size below that range or value.

Analogously, as used herein, the term “D95” or “D95 particle size” refers to a value where 95% of the particles of the sample volume have a size below that range or value.

As used herein, the term “particle size” as used herein, unless specifically stated otherwise, refers to the median particle size D50. Particle size can be measured using a laser scattering particle size analyzer, such as a HORIBA LA 910 particle size analyzer.

The terms “median particle size” and “average particle size” and D50 are used herein interchangeably.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Furthermore, certain aspects of the present disclosure may be better understood according to the following examples, which are intended to be non-limiting and exemplary in nature. Moreover, it will be understood that the compositions described in the examples may be substantially free of any substance not expressly described.

### EXAMPLES

### Example 1

Dilution of a treatment fluid in oil was tested to study the effects on emulsification of the oil in water. In Example 1, a treatment fluid, namely Tanasote™ S40 (available from Arxada) was utilized. An emulsification test, which is described in test method A35-12 from American Wood Protection Association, was used to compare each solution for the propensity to form a stable emulsion for each of the five samples. The emulsion tests were carried out in triplicate, The emulsion tests were carried out with deionized and sappy water (e.g., water that contains sap extracted from Pinus sylvestris). The separation intervals were recorded regularly and photos were taken for visual assessment of the emulsion layer and clarity of solution separation. Samples of the oil layer were taken after twenty-four hours to determine water content.

### Deionized Water Samples

The individual and average separation time for each set of triplicate solutions can be seen in FIG. 10. All diluted samples showed a very clean separation between the oil and aqueous phase. Samples of the oil phase were taken after twenty-four hours and analyzed for the water content using the Parker Kittiwake water in oil test kit.

TABLE 1

| | Water Content (%) | | | |
|---|---|---|---|---|
| Solution | Repeat 1 | Repeat 2 | Repeat 3 | Average |
| Tanasote ™ S40 | 0.09 | 0.06 | 0.12 | 0.09 |
| Nytex 801 | 0.11 | 0.08 | 0.10 | 0.10 |
| Nytex 810 | 0.06 | 0.07 | 0.10 | 0.08 |
| Nytex 820 | 0.09 | 0.12 | 0.08 | 0.10 |
| Nytex 840 | 0.11 | 0.13 | 0.10 | 0.11 |
| Nytex 8022 | 0.13 | 0.09 | 0.08 | 0.10 |

The water content of the treatment fluid prior to any dilution or emulsion tests was 0.02%. Analysis of all samples showed the water content to be no greater than 0.12%, therefore the majority of the water separated cleanly and was not absorbed into the oil phase.

Visual comparison of the samples from various time points during the separation show that all solutions had a large amount of oil droplets in the aqueous phase after five minutes, but by sixty minutes the amount of oil droplets had significantly reduced. Tanasote™ S40 treatment fluid had many more oil droplets in the aqueous phase after twenty-four hours compared to all other diluted samples.

### Sappy Water Samples

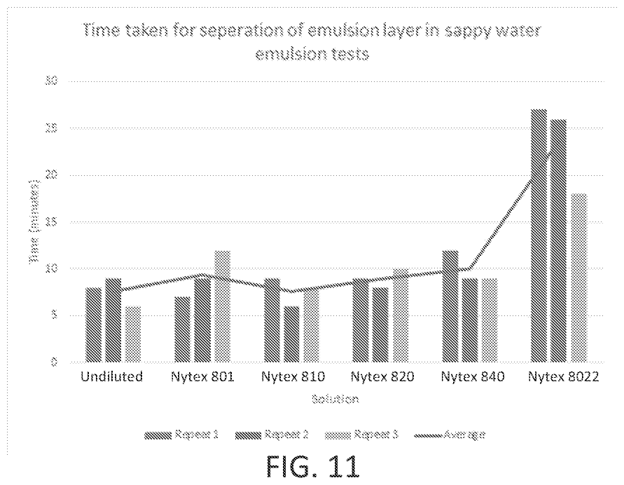

The individual and average separation time for each set of triplicate solutions can be seen in FIG. 11. Tanasote™ S40 solutions had faster or similar separation times compared to treatment fluid diluted in various Nytex solutions. Samples of the oil phase were taken after twenty-four hours and analyzed for the water content using the Parker Kittiwake water in oil test kit.

TABLE 2

| | Water Content (%) | | | |
|---|---|---|---|---|
| Solution | Repeat 1 | Repeat 2 | Repeat 3 | Average |
| Tanasote ™ S40 | 0.10 | 0.12 | 0.07 | 0.10 |
| Nytex 801 | 0.09 | 0.08 | 0.11 | 0.09 |
| Nytex 810 | 0.12 | 0.06 | 0.10 | 0.09 |
| Nytex 820 | 0.06 | 0.13 | 0.10 | 0.10 |
| Nytex 840 | 0.14 | 0.09 | 0.07 | 0.10 |
| Nytex 8022 | 0.13 | 0.12 | 0.09 | 0.11 |

Analysis of all Tanasote™ S40 samples showed the water content to be no greater than 0.12%, no significant water was retained in the oil phase.

Visual comparison of the samples from various time points during the separation show that all solutions had a larger amount of oil droplets in the aqueous phase after five minutes relative to the deionized water samples, even after twenty-four hours.

Visual assessment at various time points during the emulsion tests using deionized water showed all solutions had relatively clean separation. Visual assessment of the samples using sappy water showed separation between the oil and aqueous phase r. Analysis of the oil phase for each sample solution showed that no solution contained more than 0.12% water.

### Example 2

Various mechanisms for water removal of an oil-based preservative were investigated, including water/oil gravity separation, heat distillation, vacuum distillation, and air sparging, in the context of a fifty-liter (50 L) tank, which is representative of one or more of storage tank 110, pressure tank 120, and water separation tank 200 in system 200 (and preferably water separation tank 200), in order to establish respective rates of water removal. A specified amount of water was dosed into an oil-based preservative, namely Tanasote™ S40, that included copper and innovative co-biocidal agents, and the rate of water removal was monitored. Various parameters were evaluated, including volume of oil-based preservative used, temperature, method of water removal.

Initially, a specified amount of water was dosed into the oil-based preservative with heating to a constant temperature during the reaction. The water was allowed to disperse through the oil-based preservative, via agitation, for ten minutes prior to testing. An initial (To) sample was taken to confirm water content and that full dispersion. Progress of water removal was determined by measuring water content using a Parker Kittiwake, water-in-oil test kit, every one to two hours until either all the water had been removed or for a maximum of six hours. A summary of the initial eight water removal tests carried out to determine maximum and minimal water removal rates is below.

TABLE 3

| | | | Volume | | | | | |
|---|---|---|---|---|---|---|---|---|
| Test | | Volume of | of | | | | | |
| No. | Age | Preservative | Water | | Agitation? | Temp | Sparge? | Vacuum? |
| 1 | Fresh | 10 L | 0.25 | L | Yes | 70° C. | No | No |
| 2 | Fresh | 10 L | 0.25 | L | Yes | 70° C. | Yes | No |
| 3 | Fresh | 40 L | 1 | L | No | 50° C. | Yes | No |
| 4 | Fresh | 40 L | 1 | L | No | 50° C. | No | No |
| 5 | Fresh | 40 L | 1 | L | Yes | 50° C. | Yes | No |
| 6 | Fresh | 40 L | 1 | L | No | 70° C. | No | No |
| 7 | Fresh | 40 L | 1 | L | Yes | 50° C. | No | Yes |
| 8 | Fresh | 40 L | 1 | L | Yes | 70° C. | No | Yes |

During the initial few reactions, a notable amount of condensation was observed on the lid of the vessel. Thus, subsequent reactions were conducted with and without a lid and rates compared.

Next, the volume of the oil-based preservative was kept constant, twenty liters, with the initial water content at two and a half percent, 2.5%. The intervals between water measurements was constant, two hours. Fresh and used oil-based preservative was also evaluated. A summary of the next sixteen water removal tests carried out to determine water removal rates is below.

TABLE 4

| | | | Volume | | | | | |
|---|---|---|---|---|---|---|---|---|
| Test | | Volume of | of | | | | | |
| No. | Age | Preservative | Water | Agitation? | Temp | Sparge? | Vacuum? | Lid? |
| 9 | Fresh | 20 L | 0.5 L | Yes | 50° C. | No | No | Yes |
| 10 | Fresh | 20 L | 0.5 L | Yes | 50° C. | No | Yes | Yes |
| 11 | Fresh | 20 L | 0.5 L | Yes | 50° C. | Yes | No | Yes |
| 12 | Fresh | 20 L | 0.5 L | Yes | 50° C. | Yes | Yes | Yes |
| 13 | Fresh | 20 L | 0.5 L | Yes | 50° C. | Yes | Yes | Yes |
| 14 | Fresh | 20 L | 0.5 L | Yes | 50° C. | Yes | No | No |
| 15 | Fresh | 20 L | 0.5 L | Yes | 50° C. | No | No | No |
| 16 | Used | 20 L | 0.5 L | Yes | 50° C. | Yes | No | No |
| 17 | Used | 20 L | 0.5 L | Yes | 50° C. | Yes | Yes | Yes |
| 18 | Used | 20 L | 0.5 L | Yes | 50° C. | Yes | Yes | Yes |
| 19 | Used | 20 L | 0.5 L | Yes | 70° C. | Yes | Yes | Yes |
| 20 | Used | 20 L | 0.5 L | Yes | 70° C. | Yes | Yes | Yes |
| 21 | Used | 20 L | 0.5 L | Yes | 70° C. | Yes | No | No |
| 22 | Used | 20 L | 0.5 L | Yes | 50° C. | Yes | No | Yes |
| 23 | Used | 20 L | 0.5 L | Yes | 50° C. | No | Yes | Yes |
| 24 | Used | 20 L | 0.5 L | Yes | 50° C. | No | No | Yes |

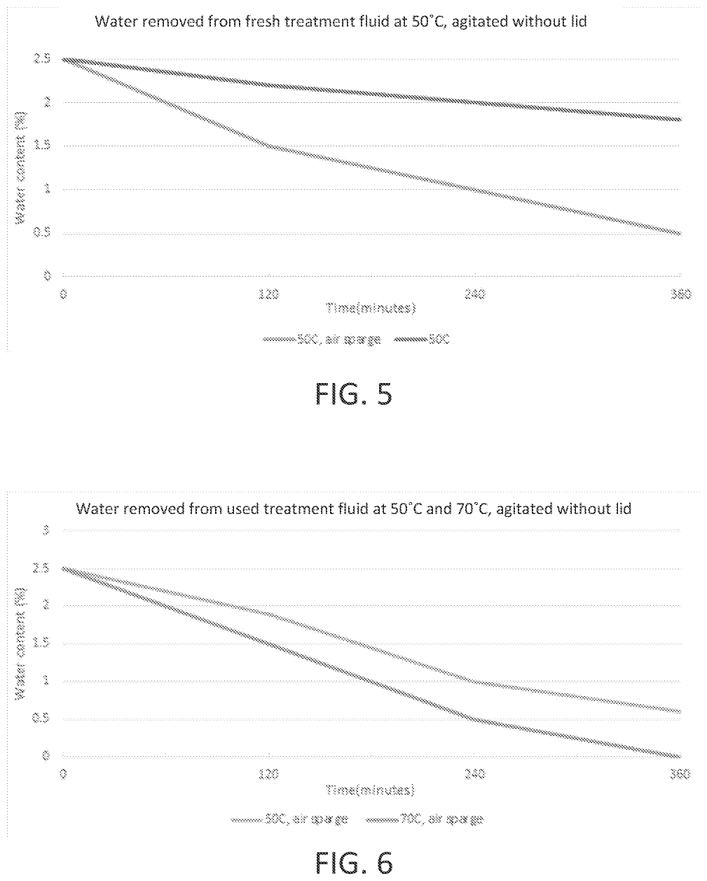

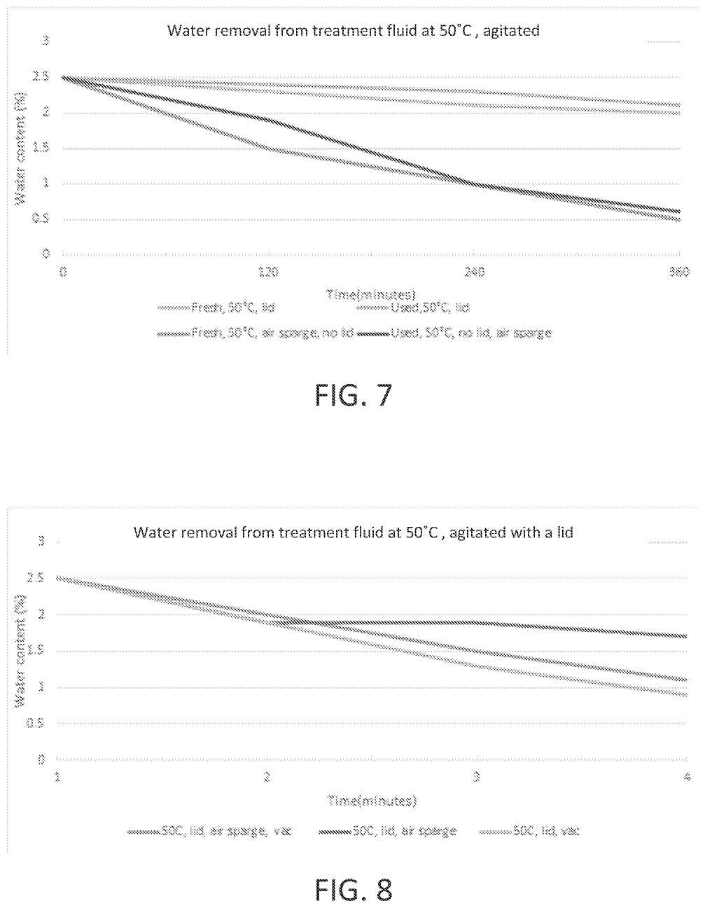

As shown in the plot in FIG. 5, air sparging significantly increased the rate of water removal relative to tests without air sparging. As shown the plot in FIG. 6, temperature also affected the rate of water removal, with higher temperature increasing the rate of water removal, 50° C. shown with the orange line and 70° C. shown with the green line. As shown the plot in FIG. 7, fresh and used oil-based preservative showed no significant differences in the rate of water removal under the same conditions, used oil-based preservative shown with the blue line and fresh oil-based preservative shown with the green line. As shown in the plot in FIG. 8, the mechanism of water removal had an effect on the rate of water removal, with a significant increase in the rate of water removal when vacuum is present.

Finally, the volume of used oil-based preservative was kept constant, twenty liters, with the initial water content at one percent, 1%. A summary of the next three water removal tests carried out to determine water removal rates is below.

TABLE 5

| | | | Volume | | | | | |
|---|---|---|---|---|---|---|---|---|
| Test | | Volume of | of | | | | | |
| No. | Age | Preservative | Water | Agitation? | Temp | Sparge? | Vacuum? | Lid? |
| 25 | Used | 20 L | 0.2 L | Yes | 60° C. | No | No | No |
| 26 | Used | 20 L | 0.2 L | Yes | 60° C. | Yes | No | No |
| 27 | Used | 20 L | 0.2 L | Yes | 60° C. | Yes | Yes | Yes |

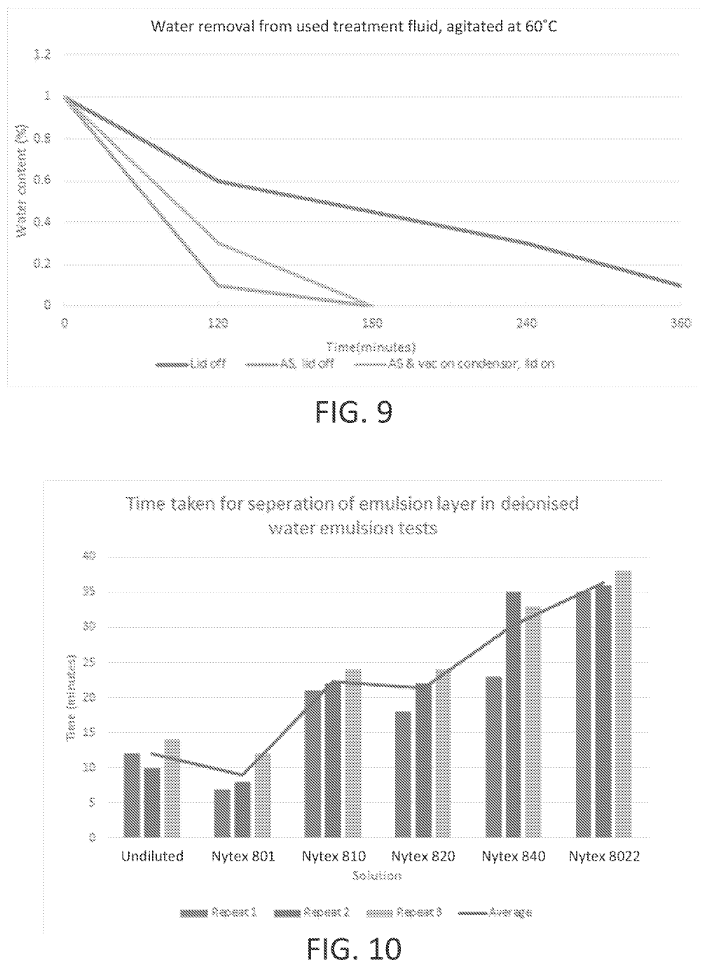

As shown in the plot in FIG. 9, the most effective method of water removal is a vented storage vessel and air sparging. Such water removal is applicable and may be used in one or more of storage tank 110, pressure tank 120, and water separation tank 200 in system 200.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A system for treating wood, comprising:
a pressure tank configured for receipt of wood for treatment;
a storage tank configured for containing a treatment fluid, the storage tank in fluid communication with the pressure tank such that the treatment fluid is flowable from the storage tank to the pressure tank;
a heater configured to heat the treatment fluid within the pressure tank to a temperature less than one hundred degrees Celsius; and
a water separation tank in fluid communication with the pressure tank such that a mixture of water and treatment fluid are flowable from the pressure tank to the water separation tank, the water separation tank comprising a bottom wall, a first outlet, and a second outlet, the bottom wall sloped towards the first outlet, the second outlet positioned above the first outlet along a vertical direction, the water from the mixture of water and treatment fluid is flowable out of the water separation tank through the first outlet, and the treatment fluid of the mixture of water and treatment is flowable out of the water separation tank through the second outlet, the second outlet in fluid communication with the storage tank such that the treatment fluid is flowable from the water separation tank to the storage tank.

2. (canceled)

3. The system of claim 1, further comprising a recovery line and a recovery pump, the recovery line extending between the pressure tank and the water separation tank, the recovery pump coupled to the recovery line, the recovery pump operable to flow the mixture of water and treatment fluid from the pressure tank to the water separation tank through the recovery line.

4. The system of claim 1, further comprising a supply line and a supply pump, the supply line extending between the storage tank and the pressure tank, the supply pump coupled to the supply line, the supply pump operable to flow the treatment fluid from the storage tank to the pressure tank through the supply line.

5. The system of claim 1, further comprising a water removal system separate from the water separation tank, the water removal system operable to remove water from the treatment fluid, the water removal system comprising one or more of a desorber, a vacuum condenser, and a centrifuge.

6. The system of claim 1, wherein the storage tank comprises an agitator operable to agitate the treatment fluid within the storage tank.

7. The system of claim 1, wherein:
a volume of the water separation tank is no less than two thousand liters and no greater than twenty thousand liters; and
a volume of the storage tank is no less than twenty-five thousand liters and no greater than three hundred thousand liters.

8. (canceled)

9. The system of claim 1, wherein the water separation tank further comprises a sparge system configured for passing one or both of air and nitrogen through the fluid in the tank to aid separation of the water and oil.

10. A method for treating wood, comprising:
exposing wood within a pressure tank to a treatment fluid, a temperature of the treatment fluid being less than one hundred degrees Celsius while the wood is exposed to the treatment fluid within the pressure tank;
after exposing the wood to the treatment fluid, transferring a mixture of water and treatment fluid from the pressure tank to a water separation tank, the water separation tank comprising a bottom wall sloped towards an outlet; and
transferring the water from the mixture of water and treatment fluid out of the water separation tank through the outlet.

11. (canceled)

12. (canceled)

13. (canceled)

14. The method of claim 10, wherein the temperature of the treatment fluid is no less than forty degrees Celsius and no greater than ninety-five degrees Celsius while the wood is exposed to the treatment fluid within the pressure tank.

15. The method of claim 10, wherein the treatment fluid comprises an oil and a micronized copper compound.

16. The method of claim 10, wherein a particle size of the micronized copper compound is no less than five nanometers and no greater than five thousand nanometers.

17. The method of claim 10, wherein the treatment fluid further comprises an organic biocide.

18. The method of claim 10, further comprising separating the water from the treatment fluid in the water separation tank for no less than ten minutes and no greater than one hundred twenty minutes after transferring the mixture of water and treatment fluid from the pressure tank to the water separation tank after a final vacuum cycle of a treatment cycle.

19. The method of claim 10, further comprising removing the wood from the pressure tank while the water separates from the treatment fluid in the water separation tank.

20. (canceled)

21. The method of claim 10, wherein the treatment fluid is substantially free of creosote.

22. A system for treating wood, comprising:
a pressure tank configured for receipt of wood for treatment;
a storage tank configured for containing a treatment fluid, the storage tank in fluid communication with the pressure tank such that the treatment fluid is flowable from the storage tank to the pressure tank;
a heater configured to heat the treatment fluid within the pressure tank to a temperature less than one hundred degrees Celsius; and
a water separation tank in fluid communication with the pressure tank such that a mixture of water and treatment fluid are flowable from the pressure tank to the water separation tank, the water separation tank comprising a bottom wall with an outlet, the bottom wall sloped towards the outlet, the water from the mixture of water and treatment fluid is flowable out of the water separation tank through the outlet.

23. (canceled)

24. The system of claim 22, further comprising a recovery line and a recovery pump, the recovery line extending between the pressure tank and the water separation tank, the recovery pump coupled to the recovery line, the recovery pump operable to flow the mixture of water and treatment fluid from the pressure tank to the water separation tank through the recovery line.

25. The system of claim 22, further comprising a supply line and a supply pump, the supply line extending between the storage tank and the pressure tank, the supply pump coupled to the supply line, the supply pump operable to flow the treatment fluid from the storage tank to the pressure tank through the supply line.

26. The system of claim 22, further comprising a water removal system separate from the water separation tank, the water removal system operable to remove water from the treatment fluid, the water removal system comprising one or more of a desorber, a vacuum condenser, and a centrifuge.

27. The system of claim 22, wherein the storage tank comprises an agitator operable to agitate the treatment fluid within the storage tank.

28. (canceled)

29. (canceled)
